(19) United States
(12) Patent Application Publication
(10) Pub. No.: US 2013/0128927 A1
(43) Pub. Date: May 23, 2013

(54) SYSTEM AND METHOD FOR DETECTING CHIRPING RADAR PULSES

(71) Applicants: Tevfik Yucek, Santa Clara, CA (US); Richard Mosko, Santa Clara, CA (US); Mahboobul Alem, Fremont, CA (US)

(72) Inventors: Tevfik Yucek, Santa Clara, CA (US); Richard Mosko, Santa Clara, CA (US); Mahboobul Alem, Fremont, CA (US)

(73) Assignee: Qualcomm Atheros, Inc., San Jose, CA (US)

(21) Appl. No.: 13/299,592

(22) Filed: Nov. 18, 2011

(51) Int. Cl. H04B 1/69; G01S 7/285

(52) U.S. Cl. 375/139; 342/20; 375/E01.001

(57) ABSTRACT

This disclosure is directed to wireless communication systems having a receiver capable of detecting chirping radar pulses. The systems and methods include processing an input signal to obtain a spectral analysis that identifies which frequency exhibits maximum signal magnitude at a given time and determines a rate of change that frequency. By determining that the rate of change is within parameters established by the pulse width range and the chirping bandwidth range, the signal can be identified as a chirping radar pulse. By comparing the rate of change to known characteristics, the signal can be identified as a chirping radar pulse. Suitable characteristics include parameters for the rate of change established by the pulse width range and the chirping bandwidth range and linearity of the rate of change.

### FIELD OF THE PRESENT INVENTION

This disclosure generally relates to wireless communication systems and more specifically to systems and methods for detecting chirping radar signals within wireless local area networks.

### BACKGROUND OF THE INVENTION

As techniques for transmitting information wireless proliferate and develop, the potential for conflicts arise, particularly with regard to the use of similar portions of the radio frequency spectrum by disparate systems. For example, Wireless Local Area Network (WLAN) devices using the 5 GHz frequency band can interfere with radar systems using similar frequencies. Conflicts are minimized when WLAN devices are configured to avoid operating on frequencies where radar signals have been detected.

Accordingly, regulatory agencies have established requirements that in order to use certain 5 GHz frequencies, the WLAN systems must be capable of Dynamic Frequency Selection (DFS.) Generally, a DFS capable master device monitors the spectrum and selects a frequency for operation that is not already in use by a radar system. Further, the master device, such as an access point (AP) in WLAN systems, must continually monitor the radio environment for radar presence. When radar use within the frequency band is detected, the AP must cease all transmissions within the required time period and dynamically recommence operation on another channel.

As is well known, a frequency band may be divided into one or more channels. The bands and channels for one form of wireless communication may be defined by, for example, the IEEE 802.11 family of standards. Generally, WLAN equipment operates in the frequency ranges of 5.15 GHz to 5.35 GHz and 5.75-5.85 GHz band, which is divided into channels of 20 MHz each. A WLAN transmitter typically transmits data through a channel to one or more WLAN receivers. Moreover, the IEEE 802.11 family of standards may also define how the data may be configured into data packets that typically include a preamble and a payload. The preamble may include training fields that typically precede the payload in each data packet. The IEEE 802.11 family of standards also defines modulation schemes such as Orthogonal Frequency-Division Multiplexing (OFDM) that use closely spaced orthogonal sub-carriers to carry the payload. Each orthogonal sub-carrier frequency is typically referred to as a “bin,” data within each bin is typically encoded for OFDM modulation with a Fast Fourier transform (FFT), and the resulting real (I) and imaginary (Q) parts of the FFT are transmitted.

Further, the IEEE 802.11n draft standard describes how a WLAN transmitter may transmit data through two channels instead of a single channel in order to increase the overall effective bandwidth of a channel, i.e. a wider channel may advantageously increase the data transfer rate. The two channels are typically chosen from within a selected band such that they do not overlap and are often referred to as a control channel and an extension channel. As in the single channel case, a preamble containing training fields precedes the payload transmission on both the control and the extension channels. The typical bandwidths of control and extension channels are the same as in the single channel case (20 MHz), which means the combined bandwidth is approximately 40 MHz.

As indicated, many specifications (e.g. IEEE 802.11 family of standards) have regulatory compliance schemes requiring that WLAN devices leave a channel when a radar signal having priority is detected and move to a non-interfering channel. In the case of a two-channel configuration, radar signals must be detected in both channels.

Radar pulses are usually narrowband and have a fixed frequency and many radar signals in the 5 GHz spectrum typically include periodic bursts of radar pulses. The bursts typically have a period of about 1 ms and the pulse duration is typically between 1-5 μs, although longer pulse durations of 50-100 μs are also possible. Commonly-owned U.S. Pat. Nos. 7,848,219 and 7,907,080, both of which are hereby incorporated by reference in their entirety, contain information regarding the detection of such radar signals.

However, radar signals used by weathers stations or military can also have a sweep signal, also known as a chirp pulse, where the frequency of the signal varies over time within a fixed bandwidth. In turn, detection of signals having these characteristics is also desirable. Indeed, detection of chirping radar pulses is required in a number of regulatory domains, including in the United States (governed by the Federal Communications Commission, FCC), in Europe (governed by the European Telecommunications Standards Institute, ETSI) and in Japan. Detection of these time-varying signals in a rapid and efficient manner is difficult using conventional methods.

Therefore, what is needed in the art are systems and methods for detecting radar signals, particularly chirping radar signals having a frequency that varies in time.

### SUMMARY OF THE INVENTION

In accordance with the above needs and those that will be mentioned and will become apparent below, this disclosure is directed to a method of detecting radar signals having a pulse width range and a chirping bandwidth range with a wireless receiver including the steps of receiving an input signal having a signal power, processing the signal to relate frequency to signal magnitude to determine a frequency exhibiting maximum signal magnitude, calculating a rate of change in the frequency exhibiting maximum signal magnitude, and determining that the rate of change is within parameters established by the pulse width range and the chirping bandwidth range.

Preferably, the method also includes determining that the signal power exceeds a threshold. Also preferably, the method includes determining that the input signal exhibits a pulse width within the pulse width range.

In one embodiment, the step of processing the signal includes performing a plurality of FFT analyses, wherein each FFT analysis identifies a frequency bin corresponding to the maximum signal magnitude obtained from the output during that FFT analysis. Preferably, calculating the rate of change in the frequency exhibiting maximum signal magnitude includes finding the difference between two frequency bins identified by sequential FFT analyses. In one aspect, the sequential FFT analyses may be successive FFT analyses or they may be separated by at least one intervening FFT analysis.

Another aspect of the disclosure involves establishing rate of change parameters such that a first rate of change parameter corresponds to the ratio of the maximum pulse width value to the minimum chirping bandwidth value and a second rate of change parameter corresponds to the ratio of the minimum pulse width value to the maximum chirping bandwidth value.

Also preferably, the method includes determining that the rate of change at a first time within the pulse width is within a maximum deviation threshold from the rate of change at a second time within the pulse width.

In yet another aspect, calculating the rate of change preferably includes calculating the rate of change a predetermined number of times and determining that the rate of change is within the parameters includes determining that each calculated rate of change is within the parameters.

This disclosure is also directed to a wireless network device for detecting radar signals having a pulse width range and a chirping bandwidth range, such that the device includes an analog section, a digital section configured to produce a spectral analysis of an input signal having a signal power by determining a frequency exhibiting maximum signal magnitude and a radar detection unit configured to calculate a rate of change in the frequency exhibiting maximum signal magnitude and determine that the rate of change is within parameters established by the pulse width range and the chirping bandwidth range. Preferably, the radar detection unit is also configured to determine that the signal power exceeds a threshold. Also preferably, the radar detection unit is further configured to determine that the input signal exhibits a pulse width within the pulse width range.

In one aspect, the digital section includes a FFT unit configured to perform a plurality of FFT analyses on the input signal, wherein each FFT analysis identifies a frequency bin corresponding to the maximum signal magnitude obtained from the output during that FFT analysis. Preferably, the radar detection unit is configured to calculate the rate of change in the frequency exhibiting maximum signal magnitude by finding the difference between two frequency bins identified by sequential FFT analyses. As desired, the sequential FFT analyses can be successive FFT analyses or FFT analyses separated by at least one intervening FFT analysis.

Another aspect includes establishing parameters such that a first rate of change parameter corresponds to the ratio of the maximum pulse width value to the minimum chirping bandwidth value and a second rate of change parameter corresponds to the ratio of the minimum pulse width value to the maximum chirping bandwidth value.

Further, the radar detection unit is preferably configured to determine that the rate of change at a first time within the pulse width is within a maximum deviation threshold from the rate of change at a second time within the pulse width.

In another aspect of the disclosure, the radar detection unit is configured to calculate the rate of change a predetermined number of times and to determine that each calculated rate of change is within the parameters.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIGS. 1A, 1B and 1C illustrate relevant characteristics of a chirping radar pulse;

FIG. 2 illustrates a functional diagram of a wireless network device for detecting chirping radar pulses, according to the invention;

FIGS. 3A and 3B are graphs showing exemplary outputs of an FFT analysis of a chirping radar pulse; and

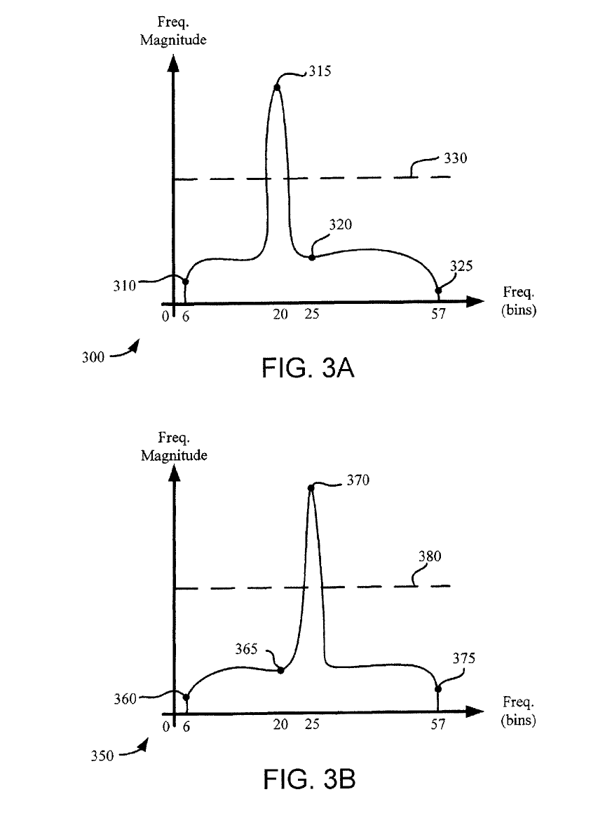

FIG. 4 schematically illustrates an algorithm for detecting chirping radar pulses, according to the invention.

### DETAILED DESCRIPTION OF THE INVENTION

At the outset, it is to be understood that this disclosure is not limited to particularly exemplified materials, architectures, routines, methods or structures as such may, of course, vary. Thus, although a number of such option, similar or equivalent to those described herein, can be used in the practice of embodiments of this disclosure, the preferred materials and methods are described herein.

It is also to be understood that the terminology used herein is for the purpose of describing particular embodiments of this disclosure only and is not intended to be limiting.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of computer-executable instructions residing on some form of computer-usable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

By way of example, and not limitation, computer-usable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), and flash memory or any other medium that can be used to store the desired information.

Communication media can embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal.

In the figures, a single block may be described as performing a function or functions; however, in actual practice, the function or functions performed by that block may be performed in a single component or across multiple components, and/or may be performed using hardware, using software, or using a combination of hardware and software. Also, the exemplary wireless network devices may include components other than those shown, including well-known components such as a processor, memory and the like.

Unless defined otherwise, all technical and scientific terms used herein have the same meaning as commonly understood by one having ordinary skill in the art to which the disclosure pertains.

Further, all publications, patents and patent applications cited herein, whether supra or infra, are hereby incorporated by reference in their entirety.

Finally, as used in this specification and the appended claims, the singular forms “a, “an” and “the” include plural referents unless the content clearly dictates otherwise.

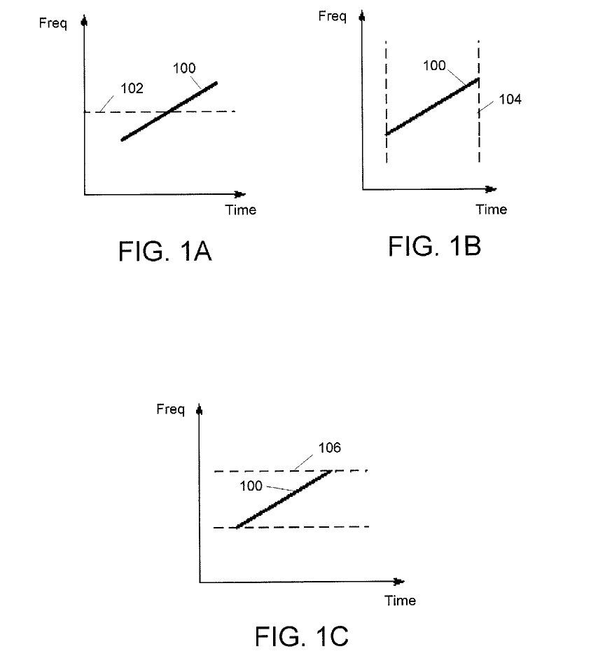

This disclosure is directed to systems and methods for detecting the presence of radar signals having known characteristics within wireless frequencies used by WLANs. As discussed above, some radar signals, such as those used by weather stations or in military applications, exhibit a signal frequency that varies over time within a fixed bandwidth. FIGS. 1A, 1B and 1C illustrate certain time-frequency characteristics of exemplary chirping radar signals. Three specific characteristics are depicted with respect to chirping pulse 100. In FIG. 1A, pulse 100 is centered around center frequency 102, for example within the 5 GHz frequency band. In FIGS. 1B and 1C, pulse 100 is shown with pulse width 104 and chirping bandwidth 106, respectively. Table 1 indicates the properties of chirping pulses currently regulated in United States, Europe and Japan. One of skill in the art will recognize that the techniques of this disclosure can be extended to detect chirping pulses having different characteristics, as well. Using the techniques of this disclosure, chirping radar signals are identified by analyzing spectral frequency data and by monitoring the power that is present in and near selected channels.

TABLE 1

| | Chirping Bandwidth | Pulse Width |
|---|---|---|
| FCC/Japan | 5 MHz-20 MHz | 50 μs-100 μs |
| ETSI | 5 MHz | 20 μs-30 μs |

Aspects of the present invention may be implemented within the hardware circuitry and/or software processes of a WLAN device operating in the 5 GHz space. Typical WLAN devices include APs, mobile terminals (nodes), or other stations within a greater wireless network. The wireless network device is configured to receive network traffic from other WLAN devices. However, it can also receive unwanted signals from other sources, such as a radar source employing a chirping radar pulse operating in the same frequency bands. The presence of such radar signals requires the wireless device to take measures to avoid transmitting on the same frequency bands as the interfering radar sources.

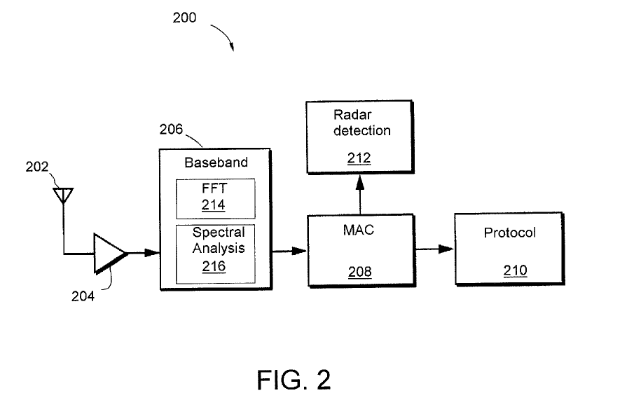

FIG. 2 illustrates a general circuit diagram of a receiver circuit for a networked WLAN device 200, such as an AP, that includes radar detection capabilities, according to one embodiment of the present invention. Input signals are received by antenna 202 and processed through a physical layer (PHY) comprising, without limitation, analog section 204 and digital section 206. Typically, analog section 204 includes a variable gain amplifier (VGA), an analog-to-digital converter (ADC) and automatic gain controller (AGC). Preferably, the AGC may be used to detect the preambles of data packets within the modulated data signal. Such preambles generally indicate that the signal corresponds to the transmission of a valid data packet and is not a radar signal. Digital section 206 includes FFT unit 214 and spectral analysis unit 216, described in further detail below.

From digital section 206, signals are then processed by Media Access Control (MAC) unit 208 and further processed by a protocol engine 210 to deliver the data payload recovered from the modulated data signal. A radar detection unit 212 employing the techniques of this disclosure interfaces with the MAC unit 208. This process can be implemented either as a software program or module executed by a processor within the wireless device, or it may be implemented as a dedicated hardware circuit coupled to the MAC layer unit, or as a combination of software and hardware. As described below, radar detection unit 212 executes radar detection algorithms and processes that allow wireless device 200 to detect and avoid interfering radar signals.

As is known in the art, signal power can be measured in the PHY layer of device 200, and is typically expressed as received signal strength indication (RSSI). For example, power can be measured by adding the absolute values or the squares of the I and Q components in the digital baseband signal. Signal power can indicate the presence of modulated data signals as well as radar signals.

Digital baseband circuit 206 includes FFT unit 214 and spectral analysis unit 216. FFT unit 214 typically performs computations on the modulated data signal to recover the payload. As is known in the art, FFT analysis of an incoming signal provides phase and magnitude information within fine frequency ranges. For example, the OFDM modulation described by the IEEE 802.11 family of standards encodes data packets with sixty-four orthogonal carrier frequencies (bins) of approximately 300 kHz each. Fifty-two bins are used for data and six bins at the beginning and end of each OFDM packet are devoted to guard bands. Other signals, including chirping radar pulses, can also be processed by FFT unit 214, preferably producing an output divided into the fifty-two bins. This output, or FFT capture, represents a spectrogram of the received signal and is examined by spectral analysis unit 216 to determine a number of characteristics suitable for detecting chirping radar pulses, including pulse width, and identification of the frequency bin having the maximum signal magnitude. As will be appreciated, providing both spectral capture and data decoding with FFT unit 214 avoids the need to provide dedicated FFT units for both functions, one of which would always be idle during normal usage. In such embodiments, FFT unit 214 is configured to demodulate OFDM data symbols and thus has an associated period of 3.2 μs, generating FFT captures of equal duration for output to spectral analysis unit 216.

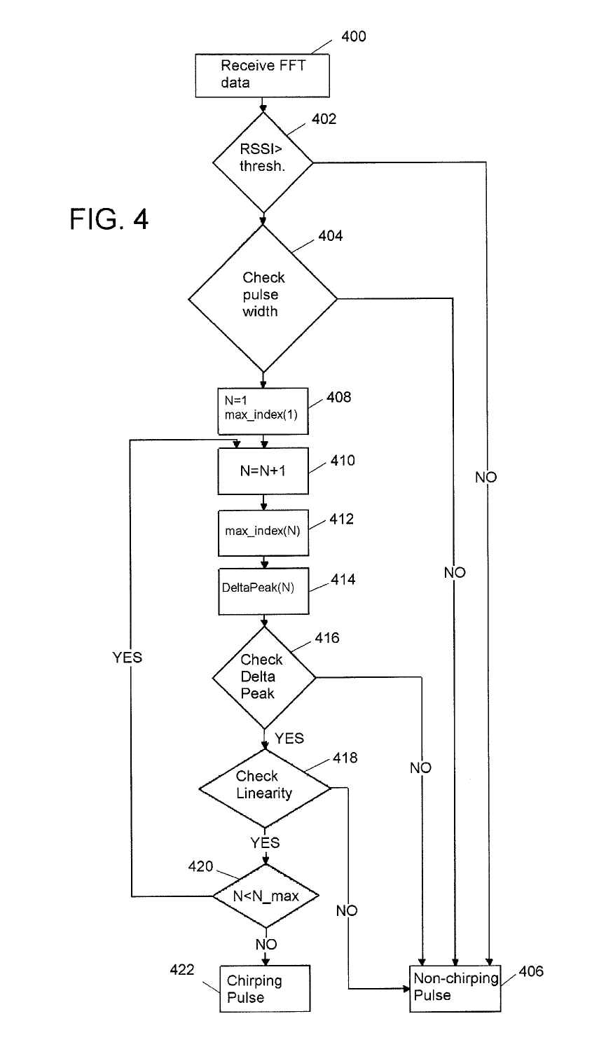

FIG. 4A is a graph 300 showing an exemplary output of the FFT unit 214. As described above, OFDM modulation encodes packets into fifty-two bins with guard bands at each end. Thus, although there may be an FFT output point for each of the sixty-four bins, only bins 6 through 57 may have a non-zero FFT magnitude (i.e., bins 0-5 and 58-63 are zero). In one embodiment, spectral analysis unit 216 examines each output point in an FFT capture and determines which bin has the largest magnitude. In this exemplary graph, only four bins are shown and the other sixty have been left off for clarity. Point 310 shows the FFT magnitude associated with bin 6, point 315 is associated with bin 20, point 320 is associated with bin 25 and point 325 is associated with bin 57. As shown in FIG. 4A, graph 300 indicates that bin 20 corresponds to maximum signal magnitude and is referred to herein as the max_index of this FFT capture.

The spectral analysis unit 216 may also compare each of the FFT output points to a threshold. In FIG. 4A, an exemplary threshold 330 is shown on the graph 300. A suitable threshold may be used to determine whether any signals are within the selected channel. In one implementation, threshold 330 is preferably determined in reference to the values returned from the spectral analysis, such as by setting threshold 330 as an offset to the maximum magnitude measured at point 315. As will be appreciated, setting threshold 330 in reference to the measured magnitudes helps provide immunity from dynamic noise.

For example, a radar signal typically exhibits power concentrated in one particular bin, that is, a specific frequency. In contrast, normal modulated data signals will typically exhibit a roughly equal magnitude across all bins. Thus, if one or only a few FFT output points are greater than the threshold 330, then a narrow band signal, such as a radar signal, may exist in the selected channel. If all of the FFT output points are greater than the threshold 330, then a wide band signal may be present in the selected channel. Finally, if no FFT output points are greater than the threshold 330, then there may be no signals in the selected channel.

In comparison, FIG. 4B is a graph 350 showing another exemplary output of the FFT unit 214 during a subsequent FFT capture. In graph 350, FFT output point 360 illustrates the FFT output magnitude corresponding to the FFT output at bin 6, point 365 corresponds to bin 20, point 370 corresponds to bin 25 and point 375 corresponds to bin 57. In this example, graph 350 indicates that bin 25 is the max_index for this FFT cycle.

Further, another exemplary threshold 380 is shown in graph 350. In this example, the threshold 380 may be similar to the threshold 330 shown in graph 300. In some cases, the threshold may be relatively fixed in order to track FFT output peaks. Other times, the threshold may be changed to adapt to different environments. For example, if there is enough noise in the channel making FFT output peak detection relatively difficult, the threshold may be increased, decreasing noise sensitivity.

In brief, analog section 204 and digital section 206 generally provide detection information to MAC unit 208, which can then be used by radar detection unit 212. As discussed above, characteristics that are reported include signal power, such as RSSI, duration information or pulse width, time of detection, frequency domain characteristics of detected pulses and the like. Some wireless communication devices may receive signals beyond the wireless communication channel. Thus, in a preferred embodiment, power measurement is limited to in-band power. Also, FFT information is generally generated only when the length of the detected pulse is long enough to allow one or more full FFTs.

Spectral analysis of the received signal is performed to relate the frequency exhibiting maximum signal magnitude to time. The rate of change in the frequency exhibiting maximum signal magnitude can then be checked against the known characteristics of chirping radar pulses. For example, sequential FFT captures can be used to detect chirping radar signals. FIG. 4 depicts the main steps of one suitable algorithm performed by radar detection unit 212 for analyzing a signal to determine whether characteristics corresponding to a chirping radar pulse are present. The algorithm can be implemented in software or hardware, as desired.

At the start of the routine, digital section 206 delivers a plurality of outputs from FFT unit 214, FFT captures(N), from 1 to N_max, that represent a potential chirping radar pulse in step 400. Next, signal power, such as RSSI, is compared to a threshold configured to indicate the potential for a radar signal in step 402. If the threshold is met, step 404 determines whether the pulse is within maximum and minimum pulse width parameters so as to qualify as a potential chirping pulse. Preferably, the maximum and minimum parameters are established based upon the types of chirping signals expected to be encountered given the device's intended use. Table 1 above provides suitable representative values. If signal power is insufficient in step 402 or if the pulse width is not within established parameters in step 404, the signal is identified as not being a chirping radar pulse and the process terminates in step 406.

For a signal meeting these criteria, the process continues to step 408. In step 408, N is set to 1 and the first FFT capture, FFT capture(1), from FFT unit 214 is analyzed to determine max_index(1). Next, step 410 increments N by 1 and leads to step 412 for analysis of FFT capture(N) from FFT unit 214 and determination of max_index(N). Since each FFT capture corresponds to the same amount of time, such as 3.2 μs, a chirping radar pulse will have a corresponding max_index(N) that moves linearly across FFT captures. As such, a plot of max_index(N) against FFT capture(N) should also be linear, with a slope dependent on the chirping bandwidth 14 and the radar pulse width 12. As will be appreciated, the slope corresponds to the rate of change in which frequency bin exhibits the maximum magnitude of FFT output. In step 414, the variable DeltaPeak(N) is assigned a value corresponding to the difference between successive max_indexs, max_index(N)-max_index(N−1). As one of skill in the art will recognize, this analysis of a chirping pulse can be expected to generate a range of possible rates of change varying from a min_delta corresponding to the smallest chirping bandwidth and longest pulse width to a max_delta corresponding to the largest chirping bandwidth and shortest pulse duration. As desired, the values for min_delta and max_delta can be determined in advance depending upon the characteristics of expected radar pulses. In step 416, the absolute value of DeltaPeak(N) is checked to determine if it is between min_delta and max_delta. If not, a negative identification is made and the routine exits at step 406.

If DeltaPeak(N) is within the parameters, an additional verification is preferably performed in step 418 to determine whether the slope of max_index(N), that is, the rate of change in which frequency bin exhibits the maximum magnitude of FFT output, remains sufficiently linear over the portion of the pulse width being analyzed. In such embodiments, the absolute value of the difference between DeltaPeak(N) and DeltaPeak(N−1) is compared to a maximum deviation threshold. A perfectly linear relationship would return a value of zero in step 418. However, to provide tolerance for perturbations and inaccuracies, it is preferable to set the maximum deviation threshold at an empirical value above zero that is low enough so that signals having non-linear frequency variation across time are not misidentified as being chirping radar pulses. Accordingly, if the difference between successive DeltaPeak(N)'s exceeds the deviation threshold, the algorithm exits at step 406 and the signal is identified as not being a chirping radar pulse.

If the rate of change in max_index(N) is sufficiently linear as determined in step 418, then step 420 determines whether enough FFT captures have been analyzed to make an adequate determination. The value N_max may be selected to represent a suitable number of FFT captures from FFT unit 214 to provide a reliable determination that the signal being analyzed is a chirping radar pulse. In one embodiment, N_max is preferably in the range of approximately 3 to 32 FFT captures, and more preferably in the range of 4 to 10 FFT captures, depending upon the pulse width of expected radar signals. Accordingly, if N is less than N_max in step 420, the process returns to step 410 for iteration to the next FFT capture. Otherwise, when N_max has been met, sufficient FFT captures have been processed to characterize the signal as a chirping radar pulse in step 422. Having made this determination, the receiver can implement its DFS routine, or other suitable scheme, to hop to another channel and avoid interference with the radar signal.

Although the algorithm depicted in FIG. 4 is tailored to determine the max_index(N) rate of change between successive FFT captures, the techniques can easily be applied to processes that examine non-consecutive FFT captures, such as every other or every third FFT capture as desired.

As will be appreciated, the above techniques use several parameters to identify chirping radar pulses, including signal power, pulse width, rate of change of max_index(N) and deviation from linearity. Consequently, determination of chirping radar pulses can be made with high reliability and very low probability of false positives.

Described herein are presently preferred embodiments. However, one skilled in the art that pertains to the present invention will understand that the principles of this disclosure can be extended easily with appropriate modifications to other applications.

What is claimed is:

1. A method of detecting radar signals having a pulse width range and a chirping bandwidth range with a wireless receiver comprising the steps of:
receiving an input signal having a signal power;
processing the signal to relate frequency to signal magnitude to determine a frequency exhibiting maximum signal magnitude;
calculating a rate of change in the frequency exhibiting maximum signal magnitude; and
determining that the rate of change is within parameters established by the pulse width range and the chirping bandwidth range.

2. The method of claim 1, further comprising the step of determining that the signal power exceeds a threshold.

3. The method of claim 1, further comprising the step of determining that the input signal exhibits a pulse width within the pulse width range.

4. The method of claim 1, wherein the step of processing the signal comprises performing a plurality of FFT analyses, wherein each FFT analysis identifies a frequency bin corresponding to the maximum signal magnitude obtained from the output during that FFT analysis.

5. The method of claim 4, wherein the step of calculating the rate of change in the frequency exhibiting maximum signal magnitude comprises finding the difference between two frequency bins identified by sequential FFT analyses.

6. The method of claim 5, wherein the sequential FFT analyses are successive FFT analyses.

7. The method of claim 5, wherein the sequential FFT analyses are separated by at least one intervening FFT analysis.

8. The method of claim 1, wherein the pulse width range has a minimum and a maximum value and the chirping bandwidth range has a minimum and a maximum value and wherein the rate of change parameters comprise a first rate of change parameter corresponding to the ratio of the maximum pulse width value to the minimum chirping bandwidth value and a second rate of change parameter corresponding to the ratio of the minimum pulse width value to the maximum chirping bandwidth value.

9. The method of claim 3, further comprising the step of determining that the rate of change at a first time within the pulse width is within a maximum deviation threshold from the rate of change at a second time within the pulse width.

10. The method of claim 3, wherein the step of calculating the rate of change comprises calculating the rate of change a predetermined number of times and wherein the step of determining that the rate of change is within the parameters comprises determining each calculated rate of change is within the parameters.

11. A wireless network device for detecting radar signals having a pulse width range and a chirping bandwidth range comprising: an analog section; a digital section configured to produce a spectral analysis of an input signal having a signal power by determining a frequency exhibiting maximum signal magnitude; and a radar detection unit configured to calculate a rate of change in the frequency exhibiting maximum signal magnitude and determine that the rate of change is within parameters established by the pulse width range and the chirping bandwidth range.

12. The wireless network device of claim 11, wherein the radar detection unit is configured to determine that the signal power exceeds a threshold.

13. The wireless network device of claim 11, wherein the radar detection unit is configured to determine that the input signal exhibits a pulse width within the pulse width range.

14. The wireless network device of claim 13, wherein the digital section comprises a FFT unit configured to perform a plurality of FFT analyses on the input signal, wherein each FFT analysis identifies a frequency bin corresponding to the maximum signal magnitude obtained from the output during that FFT analysis.

15. The wireless network device of claim 14, wherein the radar detection unit is configured to calculate the rate of change in the frequency exhibiting maximum signal magnitude by finding the difference between two frequency bins identified by sequential FFT analyses.

16. The wireless network device of claim 15, wherein the sequential FFT analyses are successive FFT analyses.

17. The wireless network device of claim 15, wherein the sequential FFT analyses are separated by at least one intervening FFT analysis.

18. The wireless network device of claim 11, wherein the pulse width range has a minimum and a maximum value and the chirping bandwidth range has a minimum and a maximum value and wherein the rate of change parameters comprise a first rate of change parameter corresponding to the ratio of the maximum pulse width value to the minimum chirping bandwidth value and a second rate of change parameter corresponding to the ratio of the minimum pulse width value to the maximum chirping bandwidth value.

19. The wireless network device of claim 13, wherein the radar detection unit is configured to determine that the rate of change at a first time within the pulse width is within a maximum deviation threshold from the rate of change at a second time within the pulse width.

20. The wireless network device of claim 13, wherein the radar detection unit is configured to calculate the rate of change a predetermined number of times and to determine that each calculated rate of change is within the parameters.
